(19) United States
(12) Patent Application Publication
(10) Pub. No.: US 2023/0388581 A1
(43) Pub. Date: Nov. 30, 2023

(54) MEDIA PLAYBACK DEVICE AND RELATED MEDIA PLAYBACK METHOD

(71) Applicant: Realtek Semiconductor Corp., HsinChu (TW)

(72) Inventors: Chun-Yi Chen, HsinChu (TW); Ching-Yao Yang, HsinChu (TW)

(73) Assignee: Realtek Semiconductor Corp., HsinChu (TW)

(21) Appl. No.: 18/144,242

(22) Filed: May 7, 2023

(30) Foreign Application Priority Data
May 27, 2022 (TW) 111119811

(51) Int. Cl. H04N 21/44; H04N 21/482; H04N 21/431; H04N 21/433; H04N 21/643

(52) U.S. Cl. CPC H04N 21/44004; H04N 21/482; H04N 21/4312; H04N 21/433; H04N 21/64322

(57) ABSTRACT

A method for performing media playback on a media playback device includes: generating a quick launch area in a user interface according to a quick launch setting, wherein the quick launch area includes a plurality of windows, and the windows correspond to at least one audio-visual (AV) content and at least one application program respectively; according to the quick launch setting, retrieving data corresponding to the at least one AV content and buffering the data in a first buffering unit; according to the quick launch setting, retrieving data required by executing the at least one application program and buffering the data in a second buffering unit; and in response to a quick launch operation, decoding the data buffered in the first buffering unit to play the AV content, or utilizing the data buffered in the second buffering unit to execute the at least one application program.

### BACKGROUND OF THE INVENTION

### 1. Field of the Invention

The present invention relates to media playback, and more particularly, to a media playback device with fast audio-visual content switching function and a related media playback method.

### 2. Description of the Prior Art

With advancement of audio/video transmission technology and hardware equipment, media playback devices can play more categories of audio-visual (AV) contents, such as, channels, programs or AV contents that are provided by digital video broadcasting (DVB) services, Internet protocol television (IPTV) services, video on demand (VOD) services, over-the-top media (OTT) services. Even, it is possible to obtain AV contents or play video games on the media playback devices by executing third-party application programs. However, while obtaining the AV contents provided by the above-mentioned services, multiple operations, such as data transmission, data format conversion, data decryption and decoding are often involved, so that the media playback device cannot immediately respond to user's switching between different AV contents. On the other hand, third-party application programs sometimes involve multi-level menu, such that the user cannot quickly and intuitively select specific AV content for on-demand playback. Hence, there is a need for providing an efficient media playback and human-machine interaction method, thereby to improve user's experience when viewing AV contents on the media playback device.

### SUMMARY OF THE INVENTION

With this in mind, it is one object of the present invention to provide a media playback device with fast AV content switching function and a related media playback method. Specifically, the present invention provides a quick launch area in a user interface of the media playback device. The quick launch area includes shortcuts for specific channels, specific programs, specific AV contents that the user can quickly switch between and play, or application programs that the user can quickly launch. The shortcuts in the quick launch area are provided by based on user's personal settings, or smart settings that are generated based on user's daily usage history. This allows the media playback device to retrieve and buffer data of specific channels, specific programs, and specific AV contents in advance, or pre-load data required by executing specific application programs. In view of this, the user can quickly switch between different AV contents by operating the quick launch area.

According to one embodiment, a method for performing media playback on a media playback device is provided. The method comprises: generating a quick launch area in a user interface of the media playback device according to a quick launch setting, wherein the quick launch area includes a plurality of quick launch windows, and the plurality of quick launch windows respectively correspond to at least one audio-visual (AV) content and at least one application program; according to the quick launch setting, retrieving data corresponding to the at least one AV content from a media source and buffering data of the at least one AV content into a first buffering unit; according to the quick launch setting, retrieving data required by executing the at least one application program from an Internet Protocol (IP) address according to the quick launch setting and buffering the data required by executing the at least one application program into a second buffering unit; and in response to a quick launch operation, selectively decoding the data buffered in the first buffering unit to play the at least one AV content or selectively utilizing the data buffered in the second buffering unit to execute the at least one application program.

According to one embodiment, a media playback device is provided. The media playback device comprises: a quick launch control circuit, a first locking device, a first buffering unit, a second locking device, a second buffering unit, a decoding circuit and a program execution circuit. The quick launch control circuit is configured to generate a quick launch area in a user interface of the media playback device according to a quick launch setting, wherein the quick launch area includes a plurality of quick launch windows, and the plurality of quick launch windows respectively correspond to at least one audio-visual (AV) content and at least one application program. The first locking device is configured to retrieve data corresponding to the at least one AV content from a media source according to the quick launch setting. The first buffering unit is configured to buffer data of the at least one AV content. The second locking device is configured to retrieve data required by executing the at least one application program from an Internet Protocol (IP) address according to the quick launch setting. The second buffering unit is configured to buffer data required by executing the at least one application program. The decoding circuit is configured to selectively decode the data buffered in the first buffering unit to play the at least one AV content in response to a quick launch operation. The program execution circuit is configured to selectively utilize the data buffered in the second buffering unit to execute the at least one application program in response to the quick launch operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a media playback device according to one embodiment of the present invention.

FIG. 2 illustrates a user interface of a media playback device and a quick launch area thereof according to one embodiment of the present invention.

FIG. 3A, FIG. 3B, FIG. 3C respectively illustrate schematic diagrams of locking devices, buffering devices, demultiplexing devices, and a program execution circuit according to embodiments of the present invention.

FIG. 4 illustrates a flow chart of a media playback method according to one embodiment of the present invention.

FIG. 5 illustrates a schematic diagram of a portion of components in a media playback device according to one embodiment of the present invention.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Reference throughout this specification to “one embodiment” or “an embodiment” means that a particular feature, structure or characteristic described in connection with the embodiment or example is included in at least one embodiment of the present embodiments. Thus, appearances of the phrases “in one embodiment” or “in an embodiment” in various places throughout this specification are not necessarily all referring to the same embodiment. Furthermore, the particular features, structures or characteristics may be combined in any suitable combinations and/or sub-combinations in one or more embodiments.

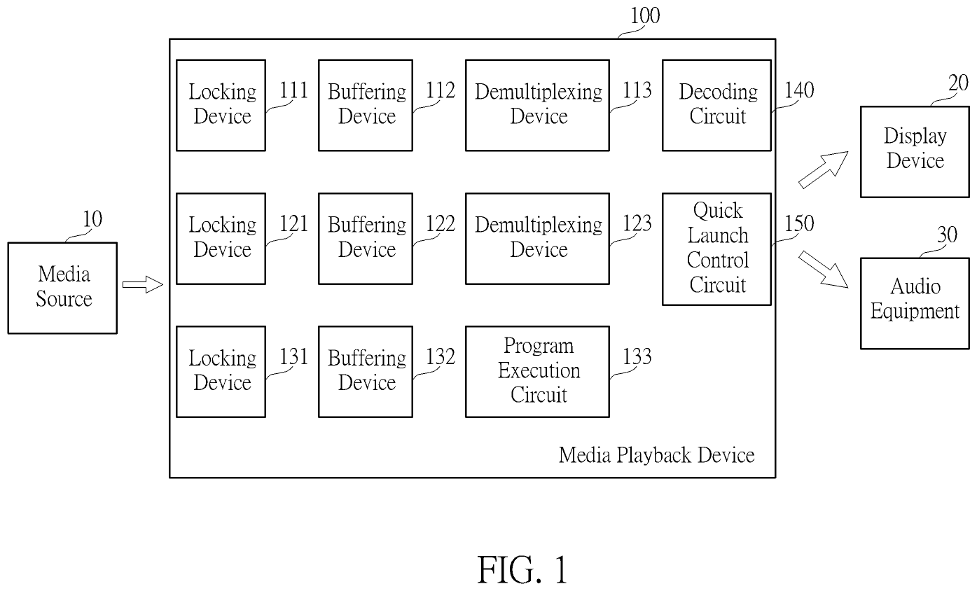

FIG. 1 is a schematic diagram of a media playback device according to one embodiment of the present invention. As shown in the figure, a media playback device 100 is configured to receive a data stream from a media source 10 for media playback. The media source 10 may be a digital video broadcasting (DVB) service, an Internet protocol television (IPTV) service, an Over-the-Top (OTT) media service, a Video-on-Demand (VOD) service or the Internet. The media playback device 100 can output video/audio signals to a display device 20 and/or audio equipment 30, through a specific video/audio transmission interface, such as High Definition Multimedia Interface (HDMI) or DisplayPort (DP), in a wired or wireless manner, so as to reproduce audio-visual (AV) contents on the display device 20 and/or the audio equipment 30. The media playback device 100 includes locking devices 111, 121 and 131, buffering devices 112, 122 and 132, demultiplexing devices 113 and 123, a program execution circuit 133, a decoding circuit 140 and a quick launch control circuit 150.

When a user intends to watch or listen to AV contents, the media playback device 100 may retrieve relevant data from the media source 10, for example, to lock a frequency point to which a specific channel belongs (if the media source 10 is the DVB service). Alternatively, the media playback device 100 may send requests to a server (if the media source 10 is an IPTV service, an OTT service, a VOD service or Internet). The AV contents will be transmitted to the media playback device 100 in the form of data streams. Specifically, the data streams may be transmitted from the media source 10 to the media playback device 100 in a wireless manner or a wired manner, through one or more relay transmission devices. In one embodiment, the data streams may include video contents compressed by a video coding format, such as Moving Picture Experts Group (MPEG), Advanced Video Coding (AVC), High Efficiency Video Coding (HEVC), or AOMedia Video 1 (AV1). Furthermore, the data streams may also include audio contents compressed by an audio coding format, such as Advanced Codec 3 (AC-3), Moving Picture Experts Group-1 or Moving Picture Experts Group-2 (MPEG-1 Audio Layer III or MPEG-2 Audio Layer III, MP3 for short), Advanced Audio Coding (AAC), MPEG and other audio coding formats. It should be noted that video/audio coding formats used for compressing audio and video contents in the data stream is not a limitation of the present invention. Depending on design requirements, different video/audio coding formats may be applied.

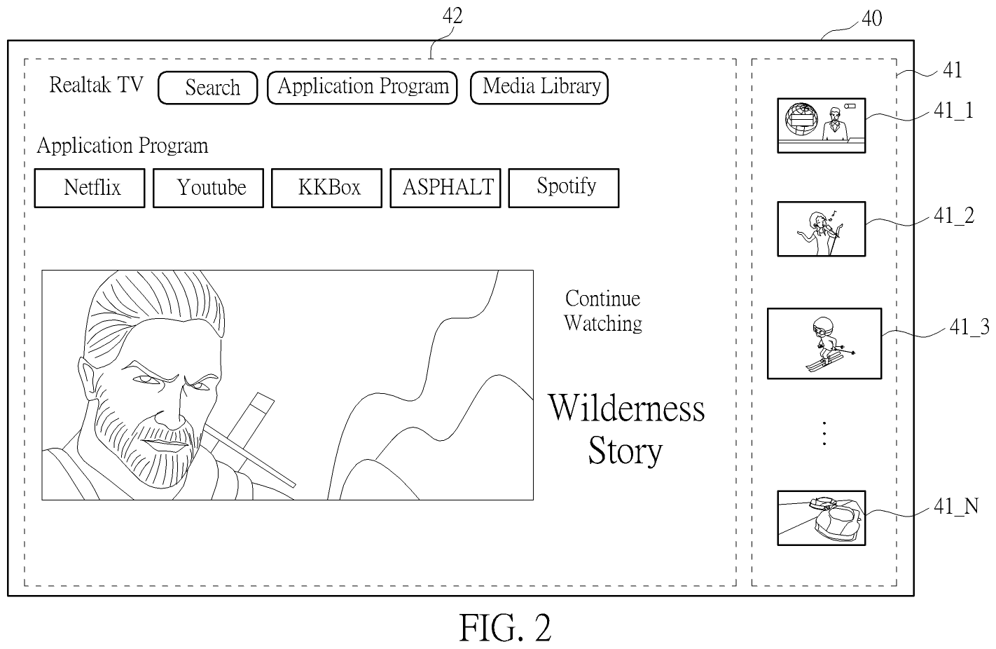

After the user turns on the media playback device 100, the media playback device 100 may first provide a start screen including a user interface 40 to the display device 20. Please refer to FIG. 2, which illustrates the user interface 40 according to one embodiment of the present invention. The user interface 40 provides a way of visual human-machine interaction, allowing the user to select, browse and search the AV content. The user interface 40 includes a quick launch area 41 and a general operation area 42. The general operation area 42 mainly displays shortcuts, representative thumbnails, and even introductions of AV contents that can be provided by the media playback device 100. The quick launch area 41 includes a plurality of quick launch windows 41_1-41_N. The quick launch windows 41_1-41_N substantially function as shortcuts to quickly switch to specific channels, programs, AV contents or third-party application programs. In one embodiment, the quick launch windows 41_1-41_N can be utilized to present a single frame (e.g., static thumbnail) or multiple frames (e.g., image sequence or video) of specific channels, specific programs, specific AV contents or specific application programs which the quick launch windows 41_1-41_N correspond to.

Furthermore, the user can use a controller to operate on the user interface 40 to select a specific channel, a specific program, or a specific AV content for playback, or launch a specific application program to watch AV content on a specific platform or play a video game. The user can use physical or virtual keys on the controller, or use a microphone on the controller to activate a quick launch function in a voice-controlled manner. Once the quick launch function is activated, the quick launch area 41 will appear on the user interface 40. The user can use the physical or virtual keys on the controller, or rely on voice control to select between the quick launch windows 41_1-41_N. Thus, the AV contents provided by the quick launch windows 41_10-41_N can be switched around. When one of the quick launch windows 41_1-41_N is selected by the user, the media playback device 100 will display a specific channel, a specific program, a specific AV content or a specific application program that corresponds to the selected quick launch window in full screen or in the general operation area 42.

In order to realize fast switching of AV contents, as long as the quick launch control circuit 150 receives user's control operation on the quick launch area 41, the quick launch control circuit 150 may retrieve corresponding data units from the buffering devices 112, 122 and 132, and send them to the decoding circuit 140 for video/audio decoding. Alternatively, the quick launch control circuit 150 may send retrieved data units to the program execution circuit 133, thereby executing application programs. The following table “Table 1” shows an example in case that the quick launch area 41 has 8 quick launch windows 41_1-41_8:

TABLE 1

| Quick | | |
|---|---|---|
| Launch | | |
| Window | Media Source | AV content |
| 41_1 | DVB | Fashion Channel |
| 41_2 | IPTV | China Television (CTV) |
| 41_3 | IPTV | Chinese Television |
| | | System (CTS) |
| 41_4 | DVB | Sport Channel |
| 41_5 | Third-Party Application | “Squid Game” |
| | (“Netflix”) | |
| 41_6 | Third-Party Application | “TVBS News Live” |
| | (“YouTube”) | |
| 41_7 | Third-Party Application | Game (“Asphalt 8”) |
| | (“Asphalt 8”) | |
| 41_8 | Third-Party Application | 2022 POP Music |
| | (“KKBOX”) | |

As can be seen from Table 1, the quick launch windows 41_1-41_8 can provide shortcuts for viewing DVB channels or IPTV channels, such that the user can easily switch to a specific channel. For third-party application programs such as “Netflix”, “YouTube” or “KKBOX” that provides AV contents, the present invention also provides viewing shortcuts, such that users can easily select and watch AV contents without having to navigate complex multi-level menus in the application programs. Please note that, in different embodiments of the present invention, the number of the quick launch windows 41_1-41_N, and channels, programs or AV contents corresponding to the quick launch windows 41_1-41_N may vary with types of media services provided by the media source 10 or user's settings. Thus, examples shown in the above Table 1 are not limitations of the present invention. In embodiments of the present invention, channels, programs, AV contents or third-party application programs corresponding to the quick launch windows 41_1-41_N can be determined by the quick launch control circuit 150 based on a quick launch setting.

Further, through the controller, the user may add previously watched channels, programs or AV content, as well as previously executed third-party application programs to the quick launch area 41 to become objects that the quick launch windows 41_1-41_N correspond to. Alternatively, the user may add channels of interest, programs of interest, AV contents of interest, or third-party application programs of interest to the quick launch area 41 to become objects that the quick launch windows 41_1-41_N correspond to. Based on the user's setting, the quick launch control circuit 150 is configured to modify the quick launch setting, such that that the settings made by the user can be reflected in the quick launch windows 41_1-41_N. In another embodiment, the quick launch control circuit 150 may record user's watch history or execution history of the third-party application programs. Then, based on statistical data, the quick launch control circuit 150 is configured to determine the channel, program or AV content that the user is most likely to watch in the future. Alternatively, based on statistical data, the quick launch control circuit 150 is configured to determine the third-party application program that the user is most likely to execute. Accordingly, the quick launch control circuit 150 adjusts and modifies the quick launch settings, and accordingly set objects that quick launch windows 41_1-41_N correspond to.

On the other hand, the quick launch control circuit 150 may also record IP addresses corresponding to previously watched channels, programs or AV contents in the quick launch setting. In this way, once the user again selects the previously watched channels, programs or AV contents, the media playback device 100 can retrieve corresponding data units more efficiently. The following Table 2 illustrates how the quick launch control circuit 150 of the present invention adds IP addresses into the quick launch setting.

TABLE 2

| Media | | |
|---|---|---|
| Source | AV content | Execution method |
| Third-Party | “Squid Game” | am start -n |
| Application | | com.netflix.ninja/.MainActivity |
| (“Netflix”) | | -a android.intent.action.VIEW -d |
| | | netflix://title/12345678 |
| Third-Party | “TVBS News Live” | am start -a |
| Application | | android.intent.action.VIEW |
| (“YouTube”) | | “https://www.youtube.com/watch? |
| | | v=2mCSYvcfhtc” |
| Third-Party | “Asphalt 8” | am start -n |
| Application | | com.android.vending/com.google. |
| (“Asphalt 8”) | | android.racing8.activities.Main |
| | | Activity |

For example, once the user executes a third-party application program “Netflix” and watches a program named “Squid Game” that is provided by “Netflix”, the quick launch control circuit 150 will record a IP address “netflix://title/12345678”, which corresponds to the program “Squid Game”, into the quick launch setting. In addition, the program “Squid Game” will be added to the quick launch area 41, such that it will be associated with one of the quick launch windows 41_1-41_N. Furthermore, once the user executes the third-party application program “YouTube” and watches the AV content named “TVBS News Live” that is provided by “YouTube”, the quick launch control circuit 150 will record an IP address “https://www.youtube.com/watch?v=2mCSYvcfhtc”, which corresponds to the AV content “TVBS News Live”, into the quick launch setting. In addition, the AV content “TVBS News Live” will be added to the quick launch area 41, such that it will be associated with one of the quick launch windows 41_1-41_N. Furthermore, for those third-party application programs such as, a video game named “Asphalt 8”, the media playback device 100 will preload and executes program codes of “Asphalt 8” in the background, so as to download data (e.g., updating or initialization data) required by executing “Asphalt 8”. On the other hand, the quick launch control circuit 150 also records playback position (e.g., breakpoints) of previously played programs or AV contents into the quick launch setting, so that the user can resume playback from the last playback position.

In order to achieve the above technical effects, the media playback device 100 of the present invention includes the locking devices 111, 121 and 131, the buffering devices 112, 122 and 132, the demultiplexing devices 113 and 123, and the program execution circuit 133, so as to buffer AV contents or preload third-party application programs. The locking devices 111, 121 and 131 are deployed for locking channels or programs provided by different types of media sources 10, respectively. The locking device 111 can lock different channels of DVB services, and the locking device 121 can send requests to specific IP addresses for data of AV contents of different channels of IPTV services. The locking device 131 can send requests to specific IP addresses for data required by executing third-party application programs, or send requests for data of AV contents provided by the third-party application programs.

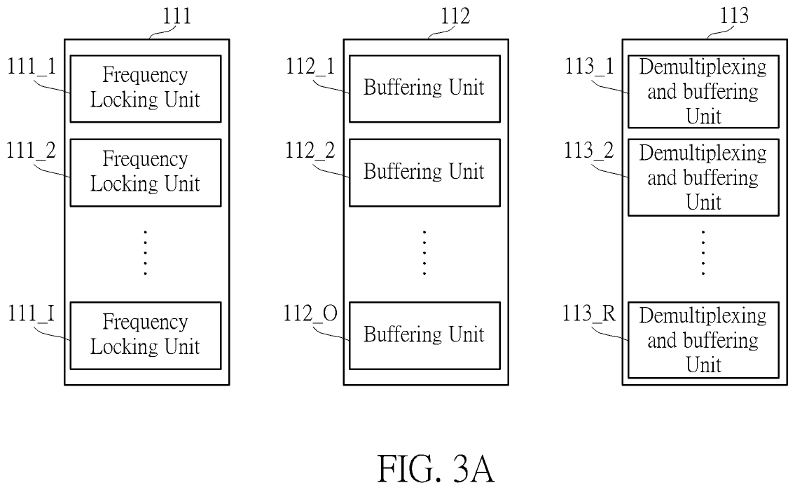

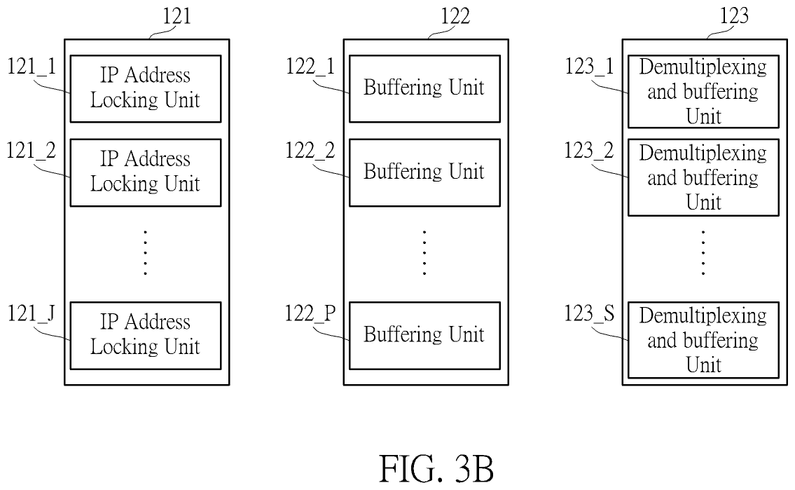

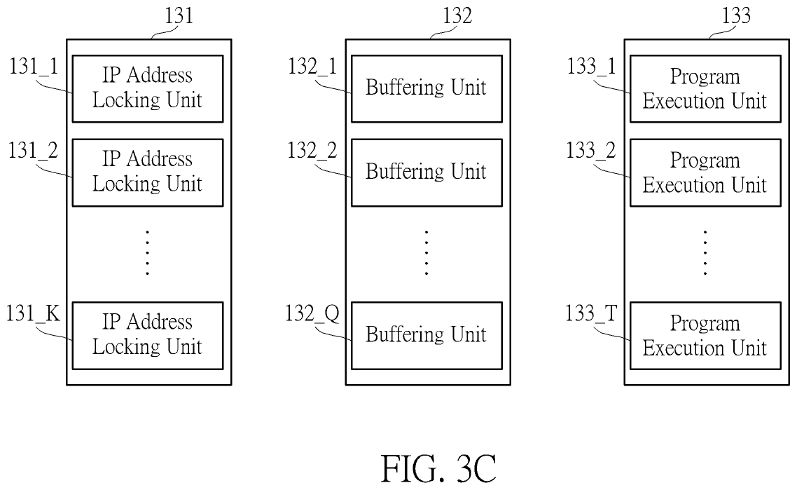

Please refer to FIG. 3A, which illustrates how the locking device 111, the buffering device 112, and the demultiplexing device 113 of the media playback device 100 buffer the data stream, thereby to provide AV contents to the quick launch windows 41_1-41_N, according to one embodiment of the present invention. Specifically, the locking device 111 includes frequency locking units 111_1-111_1 (where I is a positive integer greater than 1). The frequency locking units 111_1-111_1 are respectively configured to lock a plurality of frequency points of a digital video broadcast signal. The quick launch control circuit 150 is configured to set the frequency locking units 111_1-111_1 in the locking device 111 according to frequency points of one or more channels (e.g., Fashion channel and Sport Channel as shown in Table 1) of the DVB service that correspond to the quick launch windows 41_1-41_N and are recorded in the quick launch setting. Through the locking of the frequency locking units 111_1-111_1, the locking device 111 can retrieve data of the one or more channels from the DVB service. In addition, although not presented in the figure, the locking device 111 may also include other circuit components, such as demodulators and analog-to-digital converters, in order to demodulate the locked signals and convert them into digital signals, thereby to output data at different frequency points.

The buffering device 112 includes buffering units 112_1-112_0 for buffering the data retrieved by the frequency lock units 111_1-111_1, respectively. In some embodiments, the buffering units 112_1-112_0 may discard data units of specific types (e.g., data units that are not related to AV contents). For example, the buffering units 112_1-112_0 may discard data units corresponding to emergency broadcast, system information, and/or electronic program guide (EPG). This is achievable by checking data unit identifiers (i.e., packet identifier (PID)) in the data units. Furthermore, the demultiplexing device 113 includes demultiplexing and buffering units 113_1-113_R for performing demultiplexing, descrambling and buffering operations on the data buffered by the buffering units 112_1-112_0. Each of the demultiplexing and buffering units 113_1-113_R is associated with a specific DVB channel that one of quick launch windows 41_1-41_N corresponds to.

When the quick launch operation (which is, for example, triggered by the user) selects a quick launch window corresponding to a specific DVB channel, the decoding circuit 140 will obtain data units from an associated one of the demultiplexing and buffering units 113_1-113_R, and decode the data units to reproduce the AV content. In addition, in order for the user to easily recognize which DVB channels correspond to the quick launch windows 41_1-41_N, the decoding circuit 140 may also decode data buffered in the demultiplexing and buffering units 113_1-113_R even when the user has not selected any one of quick launch windows 41_1-41_N. As such, the quick launch windows 41_1-41_N can display a single frame (e.g., static thumbnail) or multiple frames (e.g., image sequence or video) of the DVB channels which the quick launch windows 41_1-41_N correspond to. For better understanding on principles and modification of the buffering device 112 and the demultiplexing device 113, please refer to disclosure of the U.S. patent application Ser. No. 17/319,032.

Please refer to FIG. 3B, which illustrates how the locking device 121, the buffering device 122, and the demultiplexing device 123 of the media playback device 100 buffer the data stream thereby to provide AV contents to the quick launch the windows 41_1-41_N, according to one embodiment of the present invention. The locking device 121 includes Internet Protocol (IP) address locking units 121_1-121_J (where J is a positive integer greater than 1). The IP address locking units 121_1 to 121_J are respectively configured to lock a plurality of IP addresses associated with IPTV services. The quick launch control circuit 150 is configured to set the IP address locking units 121_1-121_J in the locking device 121 according to IP addresses of one or more channels (e.g., CTV and CTS channel as shown in Table 1) of the IPTV services that the quick launch windows 41_1-41_N correspond to. Through the locking of the IP address locking units 121_1-121_J, the locking device 121 can retrieve data of the one or more channels from the IPTV services. In addition, the locking device 121 may also include other circuit components, such as demodulators and analog-to-digital converters, in order to demodulate the locked signals and convert them into digital signals, thereby to output data associated with different IP addresses. Furthermore, the buffering device 122 includes buffering units 122_1-122_P for respectively buffering the data retrieved by the IP address locking units 121_1-121_J. The demultiplexing device 123 includes demultiplexing and buffering units 123_1-123_S for performing demultiplexing, descrambling and buffering operations on the data buffered by the buffering units 122_1-122_P. Each of the demultiplexing and buffering units 123_1 to 123_S is associated with a specific IPTV channel that one of the quick launch windows 41_1-41_N corresponds to. When the quick launch operation selects a quick launch window corresponding to a specific IPTV channel, the decoding circuit 140 will obtain data units from an associated one of the demultiplexing and buffering units 123_1-123_S, and decode the data units to reproduce the AV content. In addition, in order for the user to easily recognize which IPTV channels correspond to the quick launch windows 41_1-41_N, the decoding circuit 140 may also decode data buffered in the demultiplexing and buffering units 123_1-123_S even when the user has not selected any one of quick launch windows 41_1-41_N. As such, the quick launch windows 41_1-41_N can display a single frame (e.g., static thumbnail) or multiple frames (e.g., image sequence or video) of the IPTV channels which the quick launch windows 41_1-41_N correspond to. For better understanding on principles and modification of the buffering device 122 and the demultiplexing device 123, please refer to disclosure of the U.S. patent application Ser. No. 17/319,032.

Please refer to FIG. 3C, which illustrates how the locking device 131, the buffering device 132 and the program execution circuit 133 of the media playback device 100 buffer the data stream, thereby to provide AV contents to the quick launch windows 41_1-41_N, according to one embodiment of the present invention. The locking device 131 includes IP address locking units 131_1-131_K (where K is a positive integer greater than 1). The IP address locking units 131_1-131_K are respectively configured to lock a plurality of IP addresses associated with third-party application programs. According to one or more AV contents of the third-party application programs that the quick launch windows 41_1-41_N correspond to (e.g., the drama program “Squid Game” of “Netflix”, the live show “TVBS News Live” of “YouTube”, the video game “Asphalt”, and the music playlist “2021 Pop Music” of “KKBOX”), and one or more IP addresses associated with the one or more AV contents, the quick launch control circuit 150 is configured to set the IP address locking units 131_1-131_K. Through the locking of the IP address locking units 131_1-131_K, the locking device 131 can retrieve data corresponding to the locked IP addresses. Furthermore, the locking device 131 may further include circuit other circuit components, such as demodulators and analog-to-digital converters, in order to demodulate the locked signals and convert them into digital signals, thereby to output data associated with different IP addresses. The buffering device 132 includes buffering units 132_1-132_Q for buffering the data retrieved by the IP address locking units 131_1-131_K, respectively. Furthermore, the program execution circuit 133 includes program execution units 133_1-133_T. Each of the program execution units 133_1-133_T corresponds to one or more of the quick launch windows 41_1-41_N that are associated with specific third-party application programs, respectively. The program execution units 133_1-133_T is configured to preload and execute codes of specific application programs in the background. If the quick launch operation selects a quick launch window that corresponds to a specific third-party application program, the program execution units 133_1-133_T will retrieve previously buffered data of the AV content from the buffering units 132_1-132_Q. Alternatively, the program execution units 133_1-133_T will retrieve updating data or initialization data required by executing the application program from the buffering units 132_1-132_Q. In addition, in order for the user to easily recognize the AV content of the third-party application program that the quick launch windows 41_1-41_N corresponds to, the decoding circuit 140 will utilize the data buffered by the program execution circuits 133_1-133_T for decoding even if the user does not select any one of the specific quick launch windows 41_1-41_N. As a result, a single frame (e.g., static thumbnail) or multiple frames (e.g., image sequence or video) of the specific channel can be displayed on a corresponding one of the quick launch windows 41_1-41_N.

Please note that in the above description, the media playback device 100 includes the locking device 111, the buffering device 112 and the demultiplexing device 113 that are responsible for retrieving and pre-buffering the AV contents of the DVB channels; the locking device 121, the buffering device 122 and the demultiplexing device 123 that are responsible for retrieving and pre-buffering the AV contents of the IPTV channels; and the locking device 131 and the buffering device 132 that are responsible for retrieving and pre-buffering the AV contents of the third-party application programs. However, in different embodiments, there may be different circuit designs, which depend on types of AV contents that are provided by the media playback device 100. For example, in one embodiment, the media playing device 100 may not provide the function of viewing DVB channels. Thus, the media playing device 100 in such embodiment may not have the locking device 111, the buffering device 112 and the demultiplexing device 113. In another embodiment, the media playback device 100 may have more sets of locking devices, buffering devices, and demultiplexing devices for retrieving and pre-buffering AV contents provided by services, such as VOD services or OTT services. Such design modification still falls within the scope of the present invention.

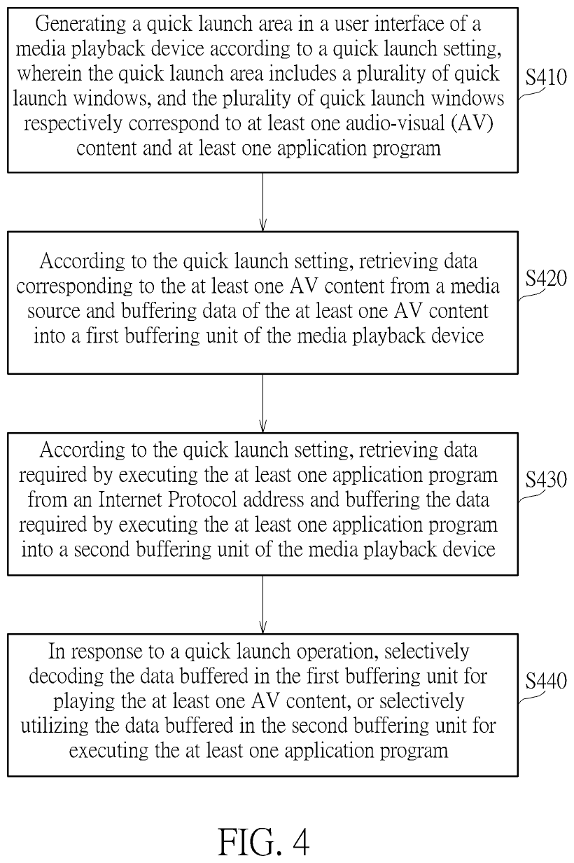

Please refer to FIG. 4, which illustrates a flow chart of a media playback method according to one embodiment of the present invention, which includes steps as follow:
S410: generating a quick launch area in a user interface of a media playback device according to a quick launch setting, wherein the quick launch area includes a plurality of quick launch windows, and the plurality of quick launch windows respectively correspond to at least one audio-visual (AV) content and at least one application program;
S420: according to the quick launch setting, retrieving data corresponding to the at least one AV content from a media source and buffering data of the at least one AV content into a first buffering unit of the media playback device;
S430: according to the quick launch setting, retrieving data required by executing the at least one application program from an Internet Protocol address and buffering the data required by executing the at least one application program into a second buffering unit of the media playback device;
S440: in response to a quick launch operation, selectively decoding the data buffered in the first buffering unit for playing the at least one AV content, or selectively utilizing the data buffered in the second buffering unit for executing the at least one application program.

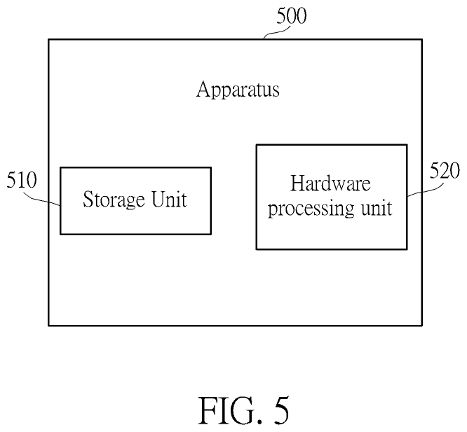

Since detailed principles, specific operations and related modifications of the above steps are explained expressly in the descriptions of the media playback device of the present invention, repeated descriptions are omitted here for the sake of brevity. One of ordinary skill in the field should be able to realize the media playback method of the present invention based on the above steps after fully understanding the foregoing descriptions. It should be noted that the above flow may be able to better realize media playback by adding other extra steps or making appropriate modifications and adjustments, thereby further improving user experience. Furthermore, all or part of operations, circuit components, and modules in the aforementioned embodiments of the present invention can be implemented by an apparatus 500 shown in FIG. 5. For example, the quick launch control circuit 150 and/or the program execution circuit 133 in the media playback device 100 can be implemented with the media playback device 100. Specifically, a storage unit 510 (e.g., non-volatile memory) in the apparatus 500 can be employed to store program codes, instructions, variables or data. A hardware processing unit 520 (e.g., a general-purpose processor) in the apparatus 500 can execute the program codes and instructions stored in the storage unit 510, and refer to the variables or data therein to perform all the operations in the foregoing embodiments.

Embodiments in accordance with the present embodiments can be implemented as an apparatus, method, or computer program product. Accordingly, the present embodiments may take the form of an entirely hardware embodiment, an entirely software embodiment, or an embodiment combining software and hardware aspects that can all generally be referred to herein as a “module”, “unit” or “system.” Furthermore, the present embodiments may take the form of a computer program product embodied in any tangible medium of expression having computer-usable program code embodied in the medium. In terms of hardware, the present invention can be accomplished by applying any of the following technologies or related combinations: an individual operation logic with logic gates capable of performing logic functions according to data signals, and an application specific integrated circuit (ASIC), a programmable gate array (PGA) or a field programmable gate array (FPGA) with a suitable combinational logic.

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. These computer program instructions can be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing media playback on a media playback device, comprising:
generating a quick launch area in a user interface of the media playback device according to a quick launch setting, wherein the quick launch area includes a plurality of quick launch windows, and the plurality of quick launch windows respectively correspond to at least one audio-visual (AV) content and at least one application program;
according to the quick launch setting, retrieving data corresponding to the at least one AV content from a media source and buffering data of the at least one AV content into a first buffering unit of the media playback device;
according to the quick launch setting, retrieving data required by executing the at least one application program from an Internet Protocol (IP) address and buffering the data required by executing the at least one application program into a second buffering unit of the media playback device; and
in response to a quick launch operation, selectively decoding the data buffered in the first buffering unit to play the at least one AV content, or selectively utilizing the data buffered in the second buffering unit to execute the at least one application program.

2. The method of claim 1, the step of buffering the data of the at least one AV content into the first buffering unit of the media playback device comprises:
utilizing a first locking device including at least one frequency locking unit to lock at least one frequency point of a broadcast signal of a Digital Video Broadcasting (DVB) service, thereby to retrieve data corresponding to an AV content of at least one DVB channel from the DVB service; and
buffering data of the AV content of the at least one DVB channel into the first buffering unit.

3. The method of claim 1, wherein the step of buffering the data of the at least one AV content into the first buffering unit of the media playback device comprises:
utilizing a first locking device including at least one Internet Protocol (IP) address locking unit to lock at least one IP address corresponding to an Internet Protocol Television (IPTV) service, thereby to retrieve data corresponding to an AV content of at least one IPTV channel from the IPTV service; and
buffering data of the AV content of the at least one IPTV channel into the first buffering unit.

4. The method of claim 1, wherein the step of buffering the data of the at least one AV content into the first buffering unit of the media playback device comprises:
utilizing a first locking device including at least one IP address locking unit to lock at least one IP address corresponding to an Over-the-top Media Service (OTT), thereby to retrieve data corresponding to an AV content from the OTT service; and
buffering data of the AV content from the OTT service into the first buffering unit.

5. The method of claim 1, wherein the step of buffering the data required by executing the at least one application program into the second buffering unit of the media playback device comprises:
utilizing a second locking device including at least one IP address locking unit to lock an IP address corresponding to the at least one application program, thereby to retrieve data required by executing the at least one application program from the IP address; and
buffering the data required by executing the at least one application program into the second buffering unit.

6. The method of claim 1, further comprising:
based on the data buffered in the first buffering unit or the data buffered in the second buffering unit, presenting a frame corresponding to the at least one AV content or presenting a frame corresponding to the at least one application program in the plurality of quick launch windows.

7. The method of claim 1, further comprising:
generating the quick launch setting according to a user's input or a watch history of a user.

8. The method of claim 1, wherein the quick launch setting includes an IP address corresponding to a watched program, a watched channel, or a watched AV content, and the method further comprises:
associating one of the plurality of quick launch windows with the watched program, the watched channel or the watched AV content; and
retrieving data of the watched program, the watched channel, or the watched AV content according to the IP address corresponding to the watched program, the watched channel or the watched AV content.

9. The method of claim 1, wherein the quick launch setting includes a playback position of a watched program or a playback position of a watched AV content, wherein the step of generating the quick launch area in the user interface of the media playback device according to the quick launch setting comprises setting the watched program or the watched AV content to be associated with one of the plurality of quick launch windows; retrieving data of the watched program or the watched AV content according to the playback position of the watched program or the playback position of the watched AV content.

10. A media playback device, comprising:
a quick launch control circuit, configured to generate a quick launch area in a user interface of the media playback device according to a quick launch setting, wherein the quick launch area includes a plurality of quick launch windows, and the plurality of quick launch windows respectively correspond to at least one audio-visual (AV) content and at least one application program;
a first locking device, configured to retrieve data corresponding to the at least one AV content from a media source according to the quick launch setting;
a first buffering unit, configured to buffer data of the at least one AV content;
a second locking device, configured to retrieve data required by executing the at least one application program from an Internet Protocol (IP) address according to the quick launch setting;
a second buffering unit, configured to buffer data required by executing the at least one application program;
a decoding circuit, configured to selectively decode the data buffered in the first buffering unit to play the at least one AV content in response to a quick launch operation; and
a program execution circuit, configured to selectively utilize the data buffered in the second buffering unit to execute the at least one application program in response to the quick launch operation.

11. The media playback device of claim 10, wherein the first locking device comprises at least one frequency locking unit; the at least one frequency locking unit is configured to lock at least one frequency point of a broadcast signal of a Digital Video Broadcasting (DVB) service and retrieve data corresponding to an AV content of at least one DVB channel from the DVB service; and the first buffering unit is configured to buffer data of the AV content of the at least one DVB channel.

12. The media playback device of claim 10, wherein the first locking device comprises at least one IP address locking unit; the at least one IP address locking unit is configured to lock at least one IP address corresponding to an Internet Protocol Television (IPTV) service and retrieve data corresponding to an AV content of at least one IPTV channel from the IPTV service; and the first buffering unit is configured to buffer data of the AV content of the at least one IPTV channel.

13. The media playback device of claim 10, wherein the first locking device comprises at least one IP address locking unit; the at least one IP address locking unit is configured to lock at least one IP address corresponding to an Over-the-top Media Service (OTT) and retrieve data corresponding to an AV content from the OTT service; and the first buffering unit is configured to buffer data of the AV content from the OTT service.

14. The media playback device of claim 10, wherein the second locking device includes at least one IP address locking unit; the at least one IP address locking unit is configured to lock an IP address corresponding to the at least one application program and retrieve data required by executing the at least one application program from the IP address; and the second buffering unit is configured to buffer the data required by executing the at least one application program.

15. The media playback device of claim 10, wherein the quick launch control circuit is configured to present a frame corresponding to the at least one AV content or a frame corresponding to the at least one application program in the plurality of quick launch windows based on the data buffered in the first buffering unit or the data in the second buffering unit.

16. The media playback device of claim 10, wherein the quick launch control circuit is configured to generate the quick launch setting according to a user's input or a watch history of a user.

17. The media playback device of claim 10, wherein the quick launch setting includes an IP address of a watched program, a watched channel, or a watched AV content; the quick launch control circuit is configured to associate the watched program, the watched channel or the watched AV content with one of the plurality of quick launch windows; the first locking device is configured to retrieve data of the watched program, the watched channel, or the watched AV content according to the IP address of the watched program, the watched channel, or the watched AV content.

18. The media playback device of claim 10, wherein the quick launch setting includes a playback position of a watched program or a playback position of a watched AV content, wherein the quick launch control circuit set the watched program or the watched AV content to be associated with one of the plurality of quick launch windows; and the first locking device retrieve data of the watched program or the watched AV content according to the playback position of the watched program or the playback position of the watched AV content.
